(19) United States
(12) Patent Application Publication
(10) Pub. No.: US 2009/0199298 A1
(43) Pub. Date: Aug. 6, 2009

(54) ENTERPRISE SECURITY MANAGEMENT FOR NETWORK EQUIPMENT

(76) Inventor: Gary S. Miliefsky, Tyngsboro, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/147,433

(22) Filed: Jun. 26, 2008

Related U.S. Application Data
(60) Provisional application No. 60/946,375, filed on Jun. 26, 2007.
(60) Provisional application No. 60/946,996, filed on Jun. 29, 2007.

(51) Int. Cl. G06F 11/30; G06F 15/16; G06F 3/048; G06F 12/14

(52) U.S. Cl. 726/25; 709/217; 715/781; 713/189

(57) ABSTRACT

The inventive device includes a dashboard or graphical user interface (GUI), a security access control (AUTH) and secure communications sub-system (SEC-COMM), network and asset discover and mapping system (NAADAMS), an asset management engine (AME), vulnerability assessment engine (CVE-DISCOVERY), vulnerability remediation engine (CVE-REMEDY), a reporting system (REPORTS), a subscription, updates and licensing system (SULS), a countermeasure communications system (COUNTERMEASURE-COMM), a logging system (LOGS), a database integration engine (DBIE), a scheduling and configuration engine (SCHED-CONFIG), a wireless and mobile devices/asset detection and management engine (WIRELESS-MOBILE), a notification engine (NOTIFY), a regulatory compliance reviewing and reporting system (REG-COMPLY), client-side (KVM-CLIENT) integration with KVM over IP or similar network management equipment, authentication-services (KVM-AUTH) integration with KVM over IP or similar network management equipment and server-side (KVM-SERVER) integration with KVM over IP or similar network management equipment.

### RELATED APPLICATION

This application claims the benefit of U.S. App. No. 60/946,375 filed on Jun. 26, 2007 and U.S. App. No. 60/946,996 filed on Jun. 29, 2007. These applications are incorporated herein by reference in their entirety.

### BACKGROUND

1. Field

The present invention relates generally to vmc for kvm over ip and more specifically it relates to a enterprise security management for network equipment for helping Information Technology (IT) Managers better see and remove the problems or flaws, also known as common vulnerabilities and exposures (CVEs), in their managed network equipment, computers, servers, hardware and related systems, which are used on a daily basis to store, edit, change, manage, control, backup and delete network-based assets.

2. Description of the Related Art

It can be appreciated that vmc for kvm over ip have been in use for years. Typically, vmc for kvm over ip are comprised of Really Simple Syndication (RSS) Clients and Servers [RSS SYSTEMS] and Information Security Countermeasures [INFOSEC COUNTERMEASURES] including but not limited to Firewalls, Virtual Private Networks (VPNs), Intrusion Detection Systems (IDS), Intrusion Prevention Systems (IPS), Smart Switches, Routers, Hubs, Patch Management Systems, Configuration Management Systems, Anti-virus Systems, Anti-spam Systems and Anti-spyware Systems.

The main problem with conventional vmc for kvm over ip are that although RSS SYSTEMS enable streamlined communications over the Internet, Wide Area Networks (WANs) and Local Area Networks (LANs), they have not been designed for, nor are they presently used for automation of INFOSEC COUNTERMEASURES. Another problem with conventional vmc for kvm over ip are that these RSS SYSTEMS do not help IT staff see the problems that exists on an everchanging daily basis within their network. Another problem with conventional vmc for kvm over ip are that these INFOSEC COUNTERMEASURES do not have a common, easy to implement communications interface that could be driven through an industry standard such as Extensible Markup Language (XML), which can be piped to IT Managers and their INFOSEC COUNTERMEASURES automatically using RSS SYSTEMS. While these devices may be suitable for the particular purpose to which they address, they are not as suitable for helping Information Technology (IT) Managers better see and remove the problems or flaws, also known as common vulnerabilities and exposures (CVEs), in their managed network equipment, computers, servers, hardware and related systems, which are used on a daily basis to store, edit, change, manage, control, backup and delete network-based assets. The main problem with conventional vmc for kvm over ip are that although RSS SYSTEMS enable streamlined communications over the Internet, Wide Area Networks (WANs) and Local Area Networks (LANs), they have not been designed for, nor are they presently used for automation of INFOSEC COUNTERMEASURES. Another problem is that these RSS SYSTEMS do not help IT staff see the problems that exists on an everchanging daily basis within their network. Also, another problem is that these INFOSEC COUNTERMEASURES do not have a common, easy to implement communications interface that could be driven through an industry standard such as Extensible Markup Language (XML), which can be piped to IT Managers and their INFOSEC COUNTERMEASURES automatically using RSS SYSTEMS.

In these respects, the enterprise security management for network equipment as disclosed herein substantially departs from the conventional concepts and designs of the prior art, and in so doing provides an apparatus primarily developed for the purpose of helping Information Technology (IT) Managers better see and remove the problems or flaws such as common vulnerabilities and exposures (CVEs), in their managed network equipment, computers, servers, hardware and related systems, which are used on a daily basis to store, edit, change, manage, control, backup and delete network-based assets.

### SUMMARY OF THE INVENTION

In view of the foregoing disadvantages inherent in the known types of vmc for kvm over ip now present in the prior art, the present invention provides a new enterprise security management for network equipment construction wherein the same can be utilized for helping Information Technology (IT) Managers better see and remove the problems or flaws, also known as common vulnerabilities and exposures (CVEs), in their managed network equipment, computers, servers, hardware and related systems, which are used on a daily basis to store, edit, change, manage, control, backup and delete network-based assets.

Enterprise security management for network equipment as disclosed herein generally include a dashboard or graphical user interface (GUI), a security access control (AUTH) and secure communications sub-system (SEC-COMM), network and asset discover and mapping system (NAADAMS), an asset management engine (AME), vulnerability assessment engine (CVE-DISCOVERY), vulnerability remediation engine (CVE-REMEDY), a reporting system (REPORTS), a subscription, updates and licensing system (SULS), a countermeasure communications system (COUNTERMEASURE-COMM), a logging system (LOGS), a database integration engine (DBIE), a scheduling and configuration engine (SCHED-CONFIG), a wireless and mobile devices/asset detection and management engine (WIRELESS-MOBILE), a notification engine (NOTIFY), a regulatory compliance reviewing and reporting system (REG-COMPLY), client-side (KVM-CLIENT) integration with KVM over IP or similar network management equipment, authentication-services (KVM-AUTH) integration with KVM over IP or similar network management equipment and server-side (KVM-SERVER) integration with KVM over IP or similar network management equipment. a dashboard or graphical user interface.

In one aspect, there is disclosed herein an agentless patch management system that provides scripts or other patches or remediation information to a vulnerabilities management console through a KVM system.

A system disclosed herein includes a vulnerability management console displayed on a device in a network, the vulnerability management console providing services to uncover known common vulnerabilities and exposures within the network, and the device including a hardware port for each of a keyboard, a video device, and a mouse; and a KVM system for accessing the hardware ports of the device, the KVM system providing a TCP/IP interface for accessing the hardware ports from a remote location through the KVM system; whereby a user can operate the vulnerability management console of the device from a remote network location.

A method disclosed herein includes providing a vulnerability management console on a device in a network, the vulnerability management console providing services to uncover known common vulnerabilities and exposures within the network; connecting a KVM system to the hardware ports of the device for a keyboard, a video device, and a mouse; and accessing the KVM system from a remote location to locally operate the vulnerability management console on the device.

The method may include transmitting a reconfiguration instruction to the vulnerability management console through the KVM system. The reconfiguration instruction may include a script for execution by the vulnerabilities management console. The method may include transmitting a patch to the device through the KVM system.

There has thus been outlined, rather broadly, features of the system in order that the detailed description thereof may be better understood, and in order that the present contribution to the art may be better appreciated. It is to be understood that the invention is not limited in its application to the details of construction and to the arrangements of the components set forth in the following description or illustrated in the drawings. Also, it is to be understood that the phraseology and terminology employed herein are for the purpose of the description and should not be regarded as limiting.

### BRIEF DESCRIPTION OF THE DRAWINGS

Various features of the systems and methods disclosed herein will be more fully appreciated with reference to the drawings wherein:

FIG. 1 shows a system for KVM management of security.

FIG. 2 shows a process for KVM management of security.

### DETAILED DESCRIPTION

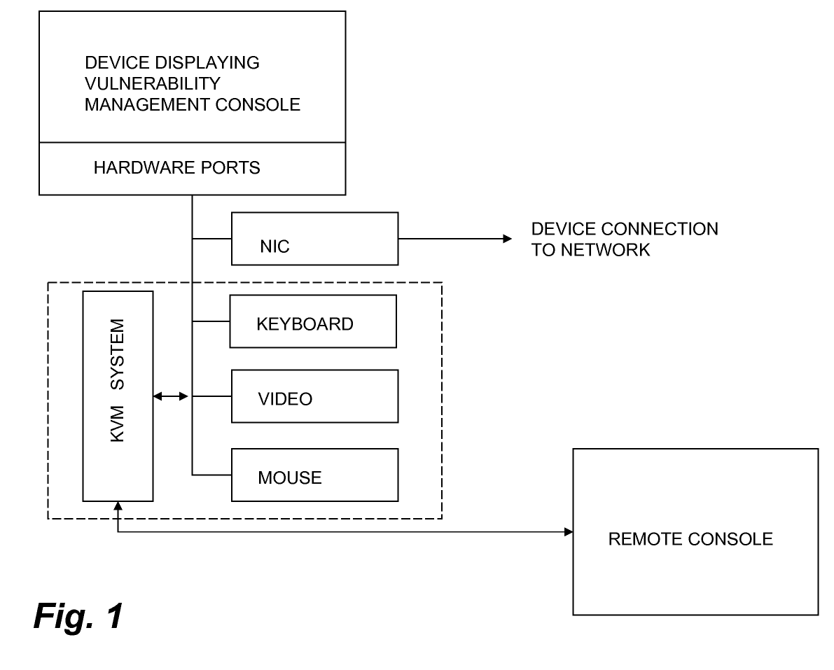

FIG. 1 shows a system for KVM management of security. The system may include a device displaying a vulnerability management console (VMC). The device may include a number of hardware ports including a network interface card or the like through which the device connects to a network (which may in turn connect to any number of other devices for which security is managed through the VMC. The hardware ports may also include a port for a keyboard, a video device, and a mouse. A KVM system may controllably assume communications between the device and the keyboard, video device, and mouse (either exclusively or shared) so that the functions of these peripheral devices can be accessed from a remote location. The KVM system may include a TCP/IP interface so that a remote console can access the KVM system through the network, effectively providing local control of and access to the device.

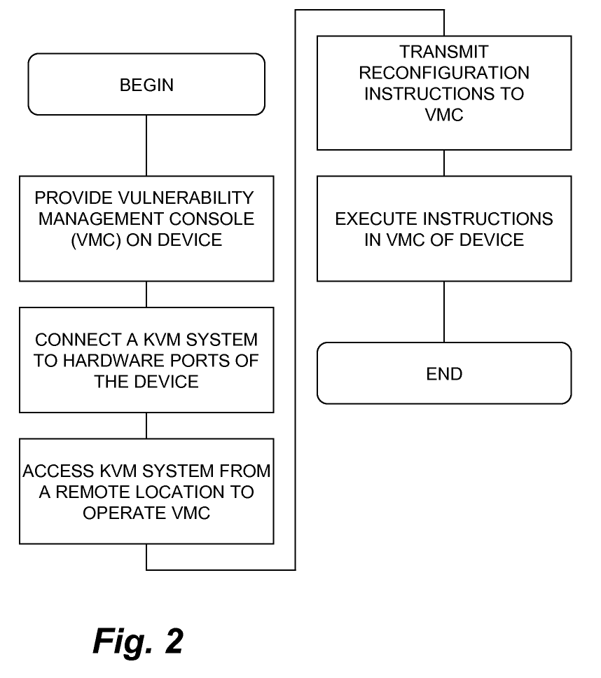

FIG. 2 shows a process for KVM management of security. The process may begin by providing a vulnerability management console on the device. A KVM system may be connected to hardware ports of the device. The KVM system may be accessed from a remote location using a TCP/IP or similar interface of the KVM system in order to operate the vulnerabilities management console from a remote location. Reconfiguration instructions may be transmitted from the remote location to the vulnerabilities management console, and these instructions may be executed within the vulnerabilities management console. The instructions may include, for example, a script to execute any number of configuration, patch, or other remediation steps within the console. The process may end.

Further details of various embodiments of the system are now discussed in greater detail.

The systems and methods disclosed herein may include a dashboard or graphical user interface (GUI), a security access control (AUTH) and secure communications sub-system (SEC-COMM), network and asset discover and mapping system (NAADAMS), an asset management engine (AME), vulnerability assessment engine (CVE-DISCOVERY), vulnerability remediation engine (CVE-REMEDY), a reporting system (REPORTS), a subscription, updates and licensing system (SULS), a countermeasure communications system (COUNTERMEASURE-COMM), a logging system (LOGS), a database integration engine (DBIE), a scheduling and configuration engine (SCHED-CONFIG), a wireless and mobile devices/asset detection and management engine (WIRELESS-MOBILE), a notification engine (NOTIFY), a regulatory compliance reviewing and reporting system (REG-COMPLY), client-side (KVM-CLIENT) integration with KVM over IP or similar network management equipment, authentication-services (KVM-AUTH) integration with KVM over IP or similar network management equipment and server-side (KVM-SERVER) integration with KVM over IP or similar network management equipment.

In certain embodiments, there is disclosed herein an enterprise security management system for network equipment. In one aspect, the disclosed system provides enterprise security management for network equipment for helping Information Technology (IT) Managers better see and remove the problems or flaws such as common vulnerabilities and exposures (CVEs) in their managed network equipment, computers, servers, hardware and related systems, which are used on a daily basis to store, edit, change, manage, control, backup and delete network-based assets. In another aspect, the disclosed system finds most or all of the common vulnerabilities and exposures (CVEs) on network-based assets such as computers, servers and related computer and network equipment and share this data with the analog and digital KVM (keyboard, video monitor and mouse) switching systems, serial connectivity devices, extension and remote access products, technologies, software and hardware. The KVM switching and connectivity solutions provide IT (information technology) managers with access and control of multiple servers and network data centers from any location. Analog, digital and serial switching solutions, as well as extension and remote access products, technologies and software, help in managing multiple servers and serially controlled devices from a single local or remote console consisting of a KVM. Switching solutions provide multiple users with the ability to control thousands of computers from any location and eliminate the need for individual KVMs for the controlled computers.

In one aspect, the systems and methods disclosed herein can help resolve through partial or full automated remediation most or all of the common vulnerabilities and exposures (CVEs) found on network-based assets such as computers, servers and related computer and network equipment and share this data with the analog and digital KVM (keyboard, video monitor and mouse) switching systems, serial connectivity devices, extension and remote access products, technologies, software and hardware. The KVM switching and connectivity solutions provide IT (information technology) managers with access and control of multiple servers and network data centers from any location. Analog, digital and serial switching solutions, as well as extension and remote access products, technologies and software, help in managing multiple servers and serially controlled devices from a single local or remote console consisting of a KVM. Switching solutions provide multiple users with the ability to control thousands of computers from any location and eliminate the need for individual KVMs for the controlled computers.

In another aspect, the systems and methods disclosed herein provide enterprise security management for network equipment that enables the client software (DESKTOP MANAGER) of the KVM over IP network management equipment marketplace to display whether in delayed or real-time methodologies, detection of rogue wired and wireless devices, laptops, mobile equipment and the like, the critical CVE information discovered on the network through automated scanning and auditing means.

In another aspect, enterprise security management for network equipment enables the client software (DESKTOP MANAGER) of the KVM over IP network management equipment marketplace to manage and display more detailed asset information such as ownership, serial number, user name, make, model, manufacturer, emergency contact, purchase or lease price and terms as well as any other relavent information that can be attributed to the asset (such as IP Address, MAC address, operating system, hardware specifications, software specifications, physical location, etc.).

In another aspect, enterprise security management for network equipment enables the client software (DESKTOP MANAGER) of the KVM over IP network management equipment marketplace to connect to a subscription service for access to IT manager related add-ons or plug-ins that will help the IT manager do a better job at managing and protecting said assets in relation to their INFOSEC countermeasures in use, proof of best practices for ISO 17799 or similar security and compliance models as well as any other relavent and useful upgrades and additions to the system. The system may share all necessary enterprise security management functionality and information with the server software (SWITCH SERVER) of the KVM over IP network management equipment marketplace to enable seemless reporting, logging and database related storage, tracking and backing up of security auditing related and vulnerability assessment information.

In another aspect, enterprise security management for network equipment shares authentication and related access control information, protocols while communications with the security services (AUTHENTICATION SERVER) enable the client software (DESKTOP MANAGER) of the KVM over IP network management equipment marketplace create seamless administrative and user access, privileges and controls.

The systems and methods disclosed herein may include one or more of the following components:

(GUI) A dashboard or graphical user interface.

(AUTH) A security access control.

(SEC-COMM) A Secure communications sub-system.

(NAADAMS) A network and asset discovery and mapping engine.

(AME) An asset management engine (e.g., nmap, ping, arp, snmp traps).

(CVE-DISCOVERY) A common vulnerabilities and discovery engine (e.g., nessus).

(CVE-REMEDY) A common vulnerabilities and remediation engine (e.g., cve autofix).

(REPORTS) A reporting system (e.g., makepdf).

(SULS) A subscription, updates and licensing system (e.g, vulnerability test updates, ip license update, upgrades, upsells, compliance docs, etc.).

(COUNTERMEASURE-COMM) A countermeasures communication system.

(LOGS) A logging system (for tracking of all activity from login/logout, configuration creation/removal, audit start/stop, report access, subscription updates, license changes, etc.).

(DBIE) A database integration engine.

(SCHED-CONFIG) A scheduling and configuration engine. This engine is used to configure and schedule audits which will detect the vulnerabilities of any network device. The scheduling part of the engine interacts with the database (DBIE) to store the configurations, with the logging engine (LOGS) to record the activity of configuring an audit, with the graphical user interface engine (GUI) to obtain user input

(WIRELESS-MOBILE) A wireless and mobile devices/asset detection and management engine. This engine dynamically detects when new devices are added or removed from the network and identifies the type of devices they are including wireless devices, laptops and other similar mobile devices. The engine stores this information in a database (see DBIE) as well as records the activity in logs (see LOGS) and interfaces with the asset management engine (AME) for tracking the assets as well as interfacing with the notification engine (NOTIFY).

(NOTIFY) A notification engine. This engine creates notifications to the end-user by way of creating emails, pages, instant messages and similar means of communication in order to alert the user of changes in their system including new vulnerabilities found on their network devices (CVE-DISCOVERY), subscription updates (SULS), report generation notifications (REPORTS), new asset discoveries.

(REG-COMPLY) A regulatory compliance reviewing and reporting system. This engine creates a mapping between the vulnerability tests available through the subscription engine (SULS) and any regulations imposed on a users network such as government regulations like HIPAA, GLBA, . . . . The engine may also interact with the reporting engine (REPORTS) and the notification engine (NOTIFY) to alert the user whether his network is or may be out of compliance with the previously mentioned regulations. The engine may also interact with the database integration engine (DBIE) for purposes of tracking compliance issues. There is also interaction between this engine and the graphical user interface (GUI) which allows the user to indicate which regulations are pertinent on their system.

(KVM-CLIENT) A client-side integration with KVM over IP or similar network management equipment.

(KVM-AUTH) An authentication-services integration with KVM over IP or similar network management equipment.

(KVM-SERVER) A server-side integration with KVM over IP or similar network management equipment.

The foregoing is considered as illustrative only. It is not desired to limit the invention to the exact construction and operation shown and described, and all suitable modifications and equivalents are intended to fall within the scope of the invention.

What is claimed is:

1. A system comprising:
a vulnerability management console displayed on a device in a network, the vulnerability management console providing services to uncover known common vulnerabilities and exposures within the network, and the device including a hardware port for each of a keyboard, a video device, and a mouse; and
a KVM system for accessing the hardware ports of the device, the KVM system providing a TCP/IP interface for accessing the hardware ports from a remote location through the KVM system;
whereby a user can operate the vulnerability management console of the device from a remote network location.

2. A method comprising:
providing a vulnerability management console on a device in a network, the vulnerability management console providing services to uncover known common vulnerabilities and exposures within the network;
connecting a KVM system to the hardware ports of the device for a keyboard, a video device, and a mouse; and
accessing the KVM system from a remote location to locally operate the vulnerability management console on the device.

3. The method of claim 2 further comprising transmitting a reconfiguration instruction to the vulnerability management console through the KVM system.

4. The method of claim 3 wherein the reconfiguration instruction includes a script for execution by the vulnerabilities management console.

5. The method of claim 2 further comprising transmitting a patch to the device through the KVM system.
